(19) United States
(12) Patent Application Publication
(10) Pub. No.: US 2012/0047011 A1
(43) Pub. Date: Feb. 23, 2012

(54) Systems and Methods for Delivering Proximity-Based Marketing Content to Mobile Devices

(75) Inventors: David Rippetoe, Nokomis, FL (US); Tyler Pitchford, Palm Beach Gardens, FL (US); Michael J. Zeto, III, Atlanta, GA (US)

(73) Assignee: PROXIMUS MOBILITY, LLC., Atlanta, GA (US)

(21) Appl. No.: 13/216,054

(22) Filed: Aug. 23, 2011

Related U.S. Application Data
(60) Provisional application No. 61/376,150, filed on Aug. 23, 2010.

(51) Int. Cl. G06Q 30/02

(52) U.S. Cl. 705/14.45; 705/14.58; 705/14.64

(57) ABSTRACT

Aspects of the present disclosure generally relate to systems and methods for delivering proximity-based marketing content to mobile devices. According to one embodiment, companies or marketers generate content (e.g., advertising content) to be distributed to mobile devices of consumers as those consumers become geographically proximate to physical locations associated with the companies or marketers. According to one embodiment, a central application server is used for purposes of generating and managing marketing content, and that content is transmitted to various client devices, routers, and/or servers (e.g., “plug” computers) for further distribution to mobile devices within a proximate range of the client devices. In one aspect, the client devices identify consumer mobile devices within a predetermined geographic area that is proximate to the client devices (e.g., based on a media access control (MAC) address associated with the mobile device), and push marketing content to those mobile devices for display to the consumers.

### CROSS-REFERENCE TO RELATED APPLICATION

This application claims benefit of and priority under 35 U.S.C. §119(e) to U.S. Provisional Patent Application No. 61/376,150, filed Aug. 23, 2010, and entitled “Proximity Marketing Platform”, which is incorporated herein by reference as if set forth herein in its entirety.

### TECHNICAL FIELD

The present disclosure relates generally to proximity-based advertising and marketing systems, and more particularly to methods and systems for the creation, syndication, and distribution of advertising and marketing content to consumer mobile devices based at least in part on a physical, geo-location or proximity of the mobile devices.

### BACKGROUND

Mobile devices (e.g., cellular phones, smartphones, PDAs, tablet computers, etc.) have become ubiquitous personal items that are carried by the vast majority of the population. These mobile devices are generally capable of a variety of tasks (in addition to making telephone calls), including browsing the Internet, downloading and using software applications (or “apps”), messaging (e.g., “text” messaging in the form of SMS and MMS messages), performing emailing and calendaring functions, and a variety of other functionalities.

Due to a typical person's frequent interaction with his or her mobile device, companies and marketers have identified mobile devices as a fertile ground for advertising and delivering other types of content. Unfortunately, however, it can be difficult to transmit such content directly to mobile device users. For example, to view a company's web page on a mobile device, the user typically must be aware of the company, and make a conscious decision to visit the company's page. Even then, the web page content may be generic to the company as a whole, and not targeted to the user's particular needs or interest, or purchasing decisions that immediately impact the user.

Additionally, physical retail or merchant locations (such as stores, casinos, resorts, restaurants, and the like) often desire to increase business in terms of attracting consumer foot traffic. Further, such retail locations often prefer to use discounts or coupons to attract consumers, but it can be difficult to get those coupons into consumers' hands. Moreover, it can be challenging to track the effectiveness or success of various marketing campaigns.

Accordingly, there is a long-felt but unresolved need for a system or method that is able to effectively distribute marketing content (and other types of content) to the mobile devices of consumers. There is a further need to be able to grab the attention of consumers that are at or near a physical retail location and attract those consumers to the retail location (or encourage them to make a purchase at the location). Additionally, there is a need for a system or method that can track the effectiveness of various types of marketing content and consumer interaction with that content, and generate consumer profiles that identify consumer purchasing trends.

### BRIEF SUMMARY

Aspects of the present disclosure generally relate to systems and methods for delivering proximity-based marketing content to mobile devices. According to one embodiment, companies or marketers generate content (e.g., advertising content, promotional offers, discounts, interactive promotional content, etc.) to be distributed to mobile devices (e.g., cellular telephones, smartphones, etc.) of consumers as those consumers become geographically proximate to physical locations associated with the companies or marketers. According to one embodiment, a central application server is used for purposes of generating and managing marketing content, and that content is transmitted to various client devices, routers, and/or servers (e.g., “plug” computers) for further distribution to mobile devices within a proximate range of the client devices. In one aspect, the client devices identify consumer mobile devices within a predetermined geographic area that is proximate to the client devices (e.g., based on a media access control (MAC) address associated with the mobile device), and push marketing content to those mobile devices for display to the consumers. In various embodiments, the consumers can then view marketing content, or “redeem” offers contained within the marketing content, for example, by showing the offer displayed on the consumer's mobile device to a representative at the physical company or marketer location, or by engaging in some other redemption mechanism (described in greater detail below).

Additionally, in one embodiment, aspects of the present system may track consumer interaction with marketing content over time to provide helpful analytics and insight into consumer purchasing behavior, the success of different types of marketing content, the success of different types of delivery mechanisms (e.g., Bluetooth v. WiFi), the physical movement patterns of consumers (e.g., through a shopping mall, casino, sports stadium, etc.), and other related marketing performance information. In other embodiments, this marketing performance information may be used to build consumer profiles for individual consumers such that subsequent marketing content may be specifically targeted or tailored to that user's preferences. For example, if it is determined over time that a given consumer only engages with certain types of content delivered via aspects of the present system, then those types of content can be highlighted and specifically sent to that consumer in the future, regardless of whether the consumer is proximate to a physical company or marketer location or not. In this example, if it becomes apparent that a given consumer will often respond to discount offers in connection with men's clothing, then certain men's clothing marketers may begin to send such discount content to the consumer's mobile device (based on pre-stored contact information) on a periodic basis, regardless of the consumer's physical location.

According to yet a further embodiment, aspects of the present system include operative connections to social media systems, such as FACEBOOK™, TWITTER™, FOURSQUARE™, and the like. In such embodiments, aspects of the present system may offer marketing content to consumers in connection with “check-in” features (or other location-based aspects) of these social media systems. For example, if a given mobile device user “checks in” at a merchant location via a social media system, then that mobile device user may automatically receive a marketing offer associated with that merchant location. Alternatively, if a user's mobile device is identified by a client device (e.g., “plug” computer) associated with an aspect of the present system, then that mobile device may be sent not only marketing content associated with a given marketer or company, but also may be automatically “checked in” via the mobile device user's social media accounts. Those of ordinary skill in the art will understand and appreciate that other social media tie-ins are contemplated by aspects of the present system, and are not limited to those specifically described herein.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary embodiment of the proximity marketing system, as described herein.

FIG. 2 shows an illustration of connections between an embodiment of the proximity marketing system and various third party components (e.g., social media systems, point-of-sale systems, etc.).

FIG. 3 illustrates an exemplary interface screen of an embodiment of the proximity marketing system.

FIG. 4 illustrates an exemplary maintenance or administration screen used by a system administrator of an embodiment of the present proximity marketing system.

FIG. 5A illustrates an exemplary campaign creation interface screen that enables system users to create and/or manage marketing campaigns within embodiments of the present proximity marketing system.

FIG. 5B illustrates an alternate embodiment of an exemplary campaign creation interface screen that enables system users to create and/or manage marketing campaigns within embodiments of the present proximity marketing system.

Referring to FIG. 6, an exemplary reporting screen is shown according to reports generated via an embodiment of the present system.

### DETAILED DESCRIPTION

Detailed embodiments of the present invention(s) are disclosed herein; however, it is to be understood that the disclosed embodiments are merely exemplary of the invention(s), which may be embodied in various forms. Therefore, specific structural and functional details disclosed herein are not to be interpreted as limiting, but merely as a basis for the claims and as a representative basis for teaching one skilled in the art to variously employ the present invention(s) in virtually any appropriately detailed structure. Further, the terms and phrases used herein are not intended to be limiting, but rather to provide an understandable description of the invention(s).

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and mechanically.

Aspects of the present disclosure generally relate to systems and methods for delivering proximity-based marketing content to mobile devices. According to one embodiment, companies or marketers generate content (e.g., advertising content, promotional offers, discounts, interactive promotional content, etc.) to be distributed to mobile devices (e.g., cellular telephones, smartphones, etc.) of consumers as those consumers become geographically proximate to physical locations associated with the companies or marketers. According to one embodiment, a central application server is used for purposes of generating and managing marketing content, and that content is transmitted to various client devices, routers, and/or servers (e.g., “plug” computers) for further distribution to mobile devices within a proximate range of the client devices. In one aspect, the client devices identify consumer mobile devices within a predetermined geographic area that is proximate to the client devices (e.g., based on a media access control (MAC) address associated with the mobile device), and push marketing content to those mobile devices for display to the consumers. In various embodiments, the consumers can then view marketing content, or “redeem” offers contained within the marketing content, for example, by showing the offer displayed on the consumer's mobile device to a representative at the physical company or marketer location, or by engaging in some other redemption mechanism (described in greater detail below).

For example, a company or marketer may comprise a clothing retailer at a local shopping mall. The retailer may desire to offer discounts to consumers passing by the retailer's location within the mall to entice the consumers to enter the retailer's store location. Thus, the retailer may utilize aspects of the present system to transmit marketing content to the mobile devices of consumers passing within a predetermined proximity of the retailer's location. As the consumer passes through this geographic area, he or she may receive content via a wireless connection (e.g., Bluetooth or WiFi), an SMS or MMS message (i.e., “text” message), an email, or even a pre-recorded phone call indicating the discount offer. In some embodiments, an opt-in procedure may need to have previously taken place for the consumer to receive such marketing content. For example, in one embodiment, a consumer must indicate via an electronic form or other prior authorization mechanism the consumer's authorization to receive marketing content via embodiments of the present system.

Additionally, in one embodiment, aspects of the present system may track consumer interaction with marketing content over time to provide helpful analytics and insight into consumer purchasing behavior, the success of different types of marketing content, the success of different types of delivery mechanisms (e.g., Bluetooth v. WiFi), the physical movement patterns of consumers (e.g., through a shopping mall, casino, sports stadium, etc.), and other related marketing performance information. In other embodiments, this marketing performance information may be used to build consumer profiles for individual consumers such that subsequent marketing content may be specifically targeted or tailored to that user's preferences. For example, if it is determined over time that a given consumer only engages with certain types of content delivered via aspects of the present system, then those types of content can be highlighted and specifically sent to that consumer in the future, regardless of whether the consumer is proximate to a physical company or marketer location or not. In this example, if it becomes apparent that a given consumer will often respond to discount offers in connection with men's clothing, then certain men's clothing marketers may begin to send such discount content to the consumer's mobile device (based on pre-stored contact information) on a periodic basis, regardless of the consumer's physical location.

According to yet a further embodiment, aspects of the present system include operative connections to social media systems, such as FACEBOOK™, TWITTER™, FOURSQUARE™, and the like. In such embodiments, aspects of the present system may offer marketing content to consumers in connection with “check-in” features (or other location-based aspects) of these social media systems. For example, if a given mobile device user “checks in” at a merchant location via a social media system, then that mobile device user may automatically receive a marketing offer associated with that merchant location. Alternatively, if a user's mobile device is identified by a client device (e.g., “plug” computer) associated with an aspect of the present system, then that mobile device may be sent not only marketing content associated with a given marketer or company, but also may be automatically “checked in” via the mobile device user's social media accounts. Those of ordinary skill in the art will understand and appreciate that other social media tie-ins are contemplated by aspects of the present system, and are not limited to those specifically described herein.

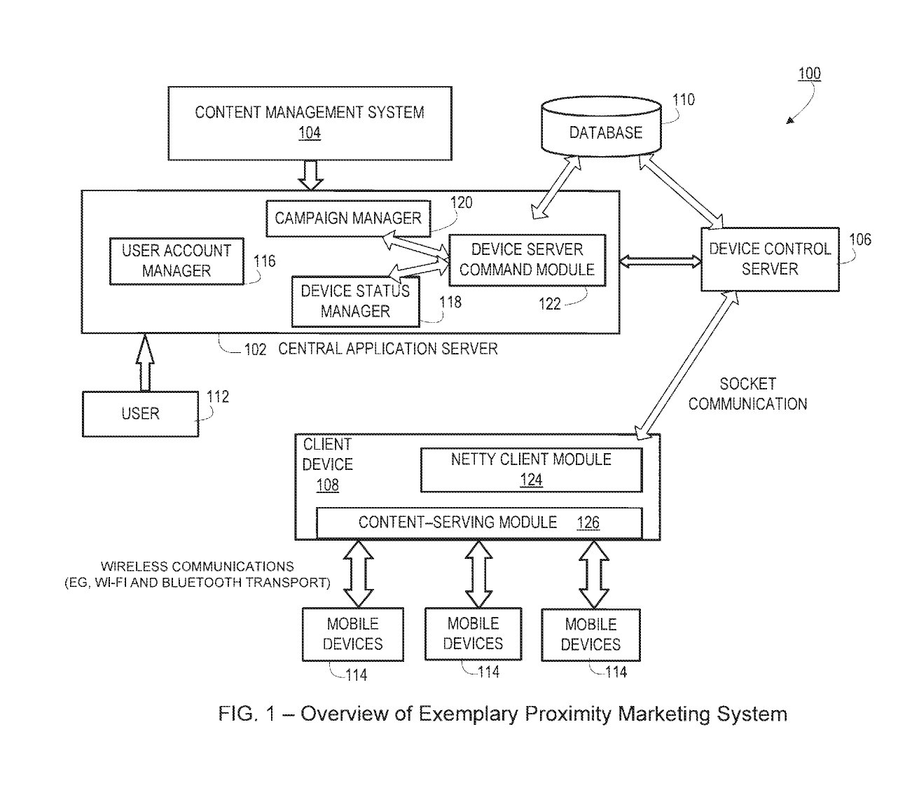

Referring now to the drawings, FIG. 1 illustrates an exemplary embodiment of the proximity marketing system 100, as described in greater detail herein. In the embodiment shown, the proximity marketing system 100 (also referred to herein as the “proximity marketing platform”) includes various components such as a central application server 102 (also referred to herein as the “application server”), a content management system (“CMS”) 104 for creation of marketing content, a device control server 106 (also referred to herein as a “control server”), a plurality of client devices 108 (e.g., “plug” computers, servers, or wireless access points), and one or more databases 110 for storing system data. As shown, one or more system users 112 (e.g., marketers, companies, individuals, etc.) interact with embodiments of the present system 100 to generate marketing content for ultimate transmission and display to a plurality of mobile devices 114 being operated by a plurality of mobile device users (e.g., consumers). In one embodiment, the application server 102 may serve as the central application portal. The application server may be hosted within a web server. In an embodiment, the application server may include a user account manager 116 that enables management of user accounts and campaigns by system users. Further, the application server may include a device status manager 118 that may be used to monitor and control client devices 108. The device status manager 118 generally comprises an algorithm or module that enables the application server to determine the statuses of the client devices 108. As will be understood and appreciated, communications, data transmissions, and the like between the various system components may be performed wirelessly via a wireless network, such as the Internet.

According to one embodiment, the content management system (“CMS”) 104 may be coupled to the application server 102 to enable creation of marketing content by system users 112. Specifically, the CMS may allow users to organize content and to create the look and feel/preview for marketing content (e.g., “campaigns”) before sending that content to client devices 108 for subsequent transmission to consumers 114. In one embodiment, the CMS may be hosted on a different web-server (e.g., JAVA) as compared to the central application server 102. In such an embodiment, the CMS may comprise a third party CMS, such as the Wap-2-Go system provided by Solutions-2-Go. In other embodiments, the CMS 104 may comprise an integrated component of the central application server 102. In various embodiments, the CMS may perform HTML editor functionality for providing website marketing content to end mobile devices 114.

As will be understood and appreciated, the marketing content created via the CMS may comprise web pages that are capable of being rendered on mobile devices, or specific offers relating to discounts or other coupons relating to goods or services, or other similar content. As described in greater detail below, this marketing content or marketing information may be delivered via a web page that is viewed via a browser on the consumer's mobile device, or via short message service (SMS) or multimedia message service (MMS) message (e.g., a “text” message), via a phone call with prerecorded voice information, or via some other similar delivery mechanism as will occur to one of ordinary skill in the art. It will be further understood and appreciated that the term “marketing content” is used for purposes of this disclosure to represent an exemplary type of content that may be pushed to mobile device users (e.g., consumers), but that such content need not necessarily relate to a marketing or advertising purpose. For example, news information, or weather information, or traditional website information, or virtually any other type of content may be transmitted to mobile device users via embodiments of the present marketing system.

Still referring to FIG. 1, embodiments of the present system utilize a campaign manager 120 for purposes of coordinating and managing marketing campaigns. As referred to herein, the term “marketing campaigns” generally refers to one or more elements of marketing content that are intended to be ultimately displayed to mobile device users. In one embodiment, the campaign manager is used to create and manage marketing campaigns, whereas the actual marketing content itself (e.g., marketing offers or website content) is created via the CMS 104. In other embodiments, the campaign manager is used for all aspects of marketing content creation, management, deployment, and analytical analysis of marketing information, and the CMS is either not utilized or comprises an integral component of the application server 102 and/or campaign manager. Additionally, the campaign manager generally performs analytical functions relating to campaign or marketing content data, such as number or percentage of consumer redemptions associated with the content, the number of advertisements that were reviewed, the number of advertisements that were rejected, the physical movement patterns of mobile device users, and other relevant analytical information as will occur to one of ordinary skill in the art.

Furthermore, the device control server 106 may communicate with the application server 102 for receiving control commands such as transmission of campaign files, reporting statuses of connected devices, and sending other control commands to the client devices 108. In one embodiment, the control server comprises a NETTY custom server. As will be understood by one of ordinary skill in the art, “NETTY” generally refers to a NIO (new I/O) client server framework that enables efficient development of network applications such as protocol servers and clients. The control server 106 may be generally used to control and communicate with the client devices 108. In an embodiment, the application code may be hosted in a NETTY environment that may be tailored for high performance asynchronous IO. In such an embodiment, the communications may be provided from the application server 102 to the device control server 106 via device server command module 122. The NETTY environment may provide support for developing custom protocols. As will be understood and appreciated, in various embodiments the device control server is discrete from the central application server 102, and the control server 106 is in operative communications with both the central application server and the client devices. In other embodiments, the device control server comprises an integrated part of the central application server (i.e., the central application server performs the functions of the device control server).

In a very specific embodiment, the control server 106 may include a NETTY Server listening at port 80 module (referred as 80 module). The 80 module may handle binary protocols and may interact directly with client devices 108 (described below). Further, the client devices may connect to the 80 module and the connections may be identified on the basis of a key, which may indicate the company_id/plug group, sent from the client devices. In an embodiment, the control server may include a NETTY Server listening at port 9090 module (referred as 9090 module). A handler may identify the appropriate connection from the connected clients list through the company_id/plug group key on receiving control notifications from the application server 102. The handler may be invoked that may initiate further transactions with the client device 108.

Still referring to FIG. 1, the client devices 108 may host a NETTY client module 124 that may be used for communication with the control server 106. The client devices may maintain a persistent socket connection with the control server. The socket connection may be used for downloading campaigns, sending ALIVE messages (e.g., status communications), transmitting log files from the client devices to the control server, and other control messages and functions. Further, the client devices may include a content-serving module 126 for delivering marketing content or other information to the mobile devices of consumers 114. In various embodiments, the content-serving module may be JAVA-based and may use Bluetooth and WiFi as the transport media while communicating with mobile devices. In other embodiments, the content-serving module may utilize MMS or SMS messages, cellular telephone calls, email communications, or other delivery mechanisms to transmit marketing content to mobile devices of end users 114. In one embodiment, the content-serving module 126 comprises a PHP serving module. As will be understood and appreciated, PHP is a general purpose scripting language originally designed for web development to produce dynamic web pages. In the current context, the PHP serving module facilitates the serving of website and other types of content to mobile devices.

Generally, the client devices 108 comprise hardware devices in the form of miniaturized servers, wireless routers, “plug” computers, or a combination of these (or other similar devices). According to one embodiment, the client devices 108 comprise “plug” computers, which are small form factor servers that consume less power as compared to traditional PCs or servers. These servers are generally also capable of transmitting a wireless signal (i.e., acting as a wireless access point or router). An example of such a plug computer is the SHEEVAPLUG™ device manufactured by Globalscale Technologies, Anaheim, Calif. Additionally, it will be understood and appreciated that although only one client device 108 is shown in FIG. 1, embodiments of the present system may utilize a plurality of client devices 108 at various physical locations as necessary.

In various embodiments, the users 112 as mentioned herein may comprise companies, marketers, individual users, organizations, and virtually any other user or group that is desirous of distributing marketing content or other types of content to mobile device users. Further, users 112 generally may include a super user, a company administrator, campaign creator, and general users. These users may log into the application server to create campaigns, dispatch campaigns to the devices and view performance reports.

As will be understood and appreciated, the various modules and managers referred to herein (and, specifically in connection with FIG. 1) generally comprise computer software algorithms, modules, routines or subroutines, or other computer languages capable of performing various process and function steps.

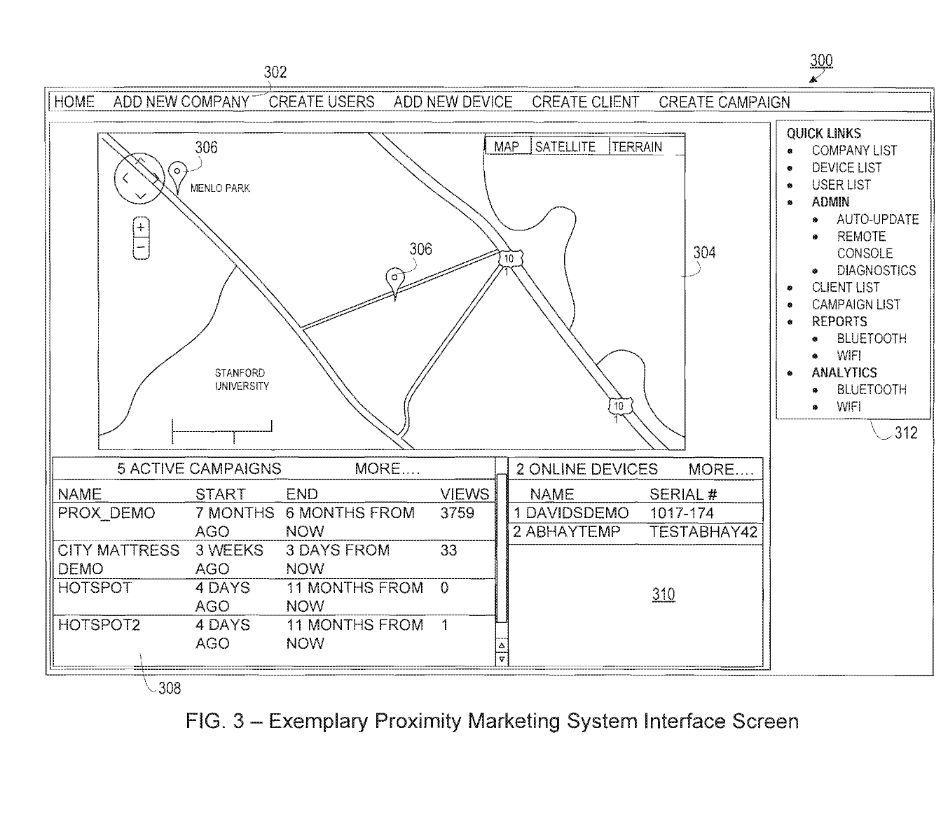

In embodiments, a user 112 may log into the application server 102 to create a marketing campaign. The user may use the CMS 104 to customize the look and feel of the campaign or marketing content. Further, the client device 108 may be plugged into the proximity marketing system 100. The client device may send a message to the control server 106, which in turn may communicate this information to the application server 102. Further, an online status of the client device 108 may be determined at a dashboard (e.g., user interface, such as that shown in FIG. 3) by a green indicator (or other similar indicator). In various embodiments, the application server may communicate with the control server via HTTP. For example, the application server may be used primarily to send control messages and parameters such that the control server may then access a database 110. The control server may also insert, update, or delete any content from the database.

In embodiments, the user 112 may decide to send the campaign to the client devices 108 for subsequent distribution to mobile device users 114. The application server may send a control command to the control server 106 that may retrieve campaign content from the database 110. Thereafter, the application server may initiate a file download session with the client device(s) 108. Once the file download session ends, the downloaded files may be extracted to a predefined directory accessible to the content-serving module 126 (e.g., JAVA-based content serving module). Further, the content-serving module may load a new campaign, add the new campaign to the current content list, and thus the new campaign may be served to the mobile devices. In an embodiment, statistics about content performance may be saved and uploaded to the control server periodically or on demand for subsequent review and analysis by system users 112.

As recited above, embodiments of the present disclosure relate to client devices (e.g., plug computers) that may support mobile content to be pushed via wireless technologies such as Bluetooth, WiFi, messaging, and the like. The client devices generally comprise hardware devices that may communicate with a campaign manager 120 and a content management module 104 to accept content files, campaign settings and parameters, website package, and other marketing information. The client device may return log files to the campaign manager indicating mobile device user 114 interaction with transmitted marketing content. Further, the campaign manager may allow users 112 to purchase client devices on their account. These users may then load content, set content rotation and time parameters, and may view reports and activities associated with a campaign. In an embodiment, an administrator may override campaign settings, prevent usage, or wipe client devices of any data from the campaign manager.

In embodiments of the present system, the WiFi functionality of the client device may depend on the development of AP or AdHoc drivers. Also, a chipset of a Bluetooth/WiFi combo device may impact the driver development and timing.

In embodiments, the client devices 108 may allow local businesses to reach consumers when the consumers may be near a point-of-sale (POS) system. In an embodiment, the client device 108 may provide a hardware platform for advertising on mobile devices 114 used by the consumers. The client device may be installed with an operating system such as Devian Linux 5.04 and Ubuntu Linux 10.04, and the like. Further, the client device may support pushing of advertisements and other marketing content or similar content to mobile devices via wireless technologies such as Bluetooth, WiFi, and the like. The wireless technologies may be supported by software that may include open source software like BlueZ Bluetooth Drivers, Bluecove Java Bluetooth Bridge, Grails Java Web Framework, NETTY v.3 NIO Framework, Apache, Tomcat6, JAVAv5, and the like. The software such as JAVAv5 may be used for page generation/serving. In an embodiment, the client device may support various formats of files to be transferred during pushing of marketing content. Examples of various formats may include, but are not limited to, JPG, GIF, PNG, BMP, 3GP, 3GPP, H263, JAD, JAR, Flash, HTML, TXT, and MP3. Further, as mentioned above, marketing content may also be pushed to mobile devices via SMS or MMS messaging, email, audio messages, phone calls, or other similar delivery mechanisms as will occur to one of ordinary skill in the art.

In embodiments, the client device 108 (e.g., plug computer) may use a universal serial bus (USB)-enabled device, such as a Bluetooth and a WiFi enabled device, for communication between the client device and the mobile devices 114. The USB-enabled device may interface with the client device and the mobile device through different wireless technologies. For example, the USB-enabled device may communicate with the client device through WiFi and with the mobile devices through Bluetooth. Alternatively, the USB-enabled device may communicate with the client device through Bluetooth and with the mobile devices through WiFi. Further, drivers used for the USB-enabled device may include a BlueZ Bluetooth driver, a WiFi master AP mode driver, or the like.

In embodiments, the client device 108 may include several enhancements to allow efficient data synchronization with the campaign manager 120. The client device may support offline logging for a predetermined period of time (e.g., 30 days, 90 days, etc.). Further, transaction data from wireless transactions may be stored on the client device and, once connected to the Internet, the stored data may be transmitted to a server for reporting. For example, if the client device 108 includes operative connections to payment systems at a merchant location (e.g., where the client device is located and with which it is associated), then redemptions of marketing content occurring at the merchant location can be tracked within the client device. In an embodiment, a USB solution may be developed to load campaign files to client devices that are not connected to the Internet and download log files from the client devices. Log files may then be manually uploaded into the campaign manager 120 for reporting purposes.

In another embodiment, a firmware inside the client device 108 may be updated remotely along with troubleshooting of the client device. Further, a device administration module (not shown) may allow remote updating and enhancements to the client devices connected to the Internet (or other similar network) in the field. This embodiment may utilize a NIO and NETTY client or through a secure shell (SSH) client. In various embodiments, and as will be understood and appreciated by those of ordinary skill in the art, Linux and its custom JAVA software may be utilized for any type of hardware devices that support Bluetooth and WiFi.

In one embodiment, a 3G GSM/EDGE embedded modem (or other similar modem device, such as a 4G or other high-speed modem) may be used as another hardware component. The 3G GSM/EDGE embedded modem may connect to the client devices via a USB port (or other similar port or connection mechanism). This 3G connectivity may provide true location-based parameters associated with the mobile devices 114, and additional backhaul and short message service (SMS). Further, location detection and tracking may comprise part of the hardware. In a certain embodiment, network-based or location-based services may be utilized to integrate and create “geo-fences” or boundaries for proximity messaging (see subsequent discussion for further information). For example, certain client devices 108 can be programmed to only push marketing content to mobile devices 114 within a predetermined geographical/physical range or proximity. This can be useful, for example, when many client devices are used in a shopping mall and are associated with different retailers or shops within the mall. Similarly, a casino or resort user 112 may desire that each client device 108 be located in a certain section of the facility, and thus consumers passing through that section of the facility will receive marketing content relating only to happenings in that specific section.

Still referring to FIG. 1, and as mentioned previously, the presently-described proximity marketing system 100 may include a campaign manager 120 and a content management module 104. The marketing system may be web-based and may host a “multi-tenant application.” The multi-tenant application may allow multiple companies 112 to have their own self managed accounts within the system. Further, the marketing system 100 is capable of simultaneously supporting multiple campaigns, websites, content types, geo targeting, and other similar functionalities. In an embodiment, the marketing system may provide customizable, real-time analytics.

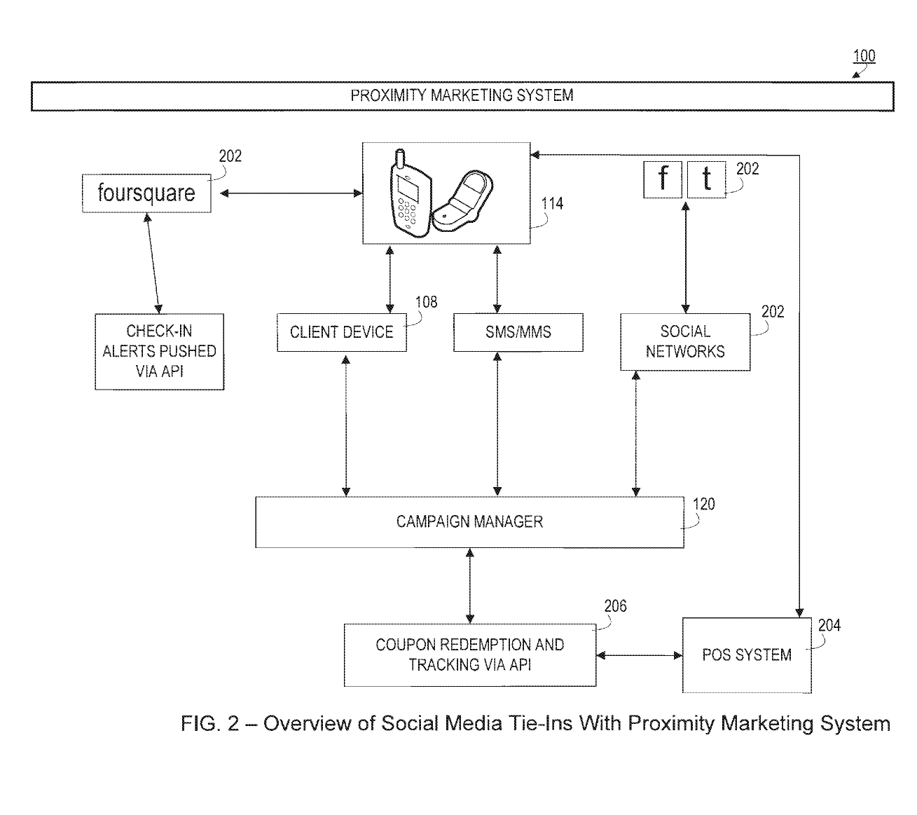

Referring now to FIG. 2, an illustration is shown of connections between an embodiment of the proximity marketing system 100 and various third party systems (e.g., social media systems, point-of-sale systems, etc.). In various embodiments, the campaign manager 120 may work in co-ordination with various third party systems and web and mobile applications, such as point of sale (POS) systems 204, coupon redemption systems 206, social networks 202 (e.g., FACEBOOK™, TWITTER™, FOURSQUARE™, etc.), and other systems. For example, the campaign manager may alert and notify the users of the web and mobile applications (i.e., owners of mobile devices 114) about advertisements in an area where a client device 108 may be placed. The client devices 108 may push check-in alerts via an application programming interface (API). In an embodiment, users 112 may create a REST-based API for third-party integrations with the POS software companies or third party partners. Partner integrations may include third party software platforms such as M-Dot Network's coupon redemption system. The users may redeem discount coupons at POS systems of the shopping stores that may have integrated software platforms such as M-Dot and the like. The users may receive discount coupons on their mobile devices 114 through the campaign manager. Further, the software platforms may be able to track content redemption at the POS systems. In an embodiment, users of location-based social networking services, such as GOWALLA™ and FOURSQUARE™, and location-based social mapping services, such as LOOPT™, may be notified based on API functionality.

Still referring to FIG. 2, in one embodiment, social networking services (or social media systems) integrate with aspects of the present proximity marketing system 100 to enable coordination amongst these systems. For example, if a user of a mobile device 114 is identified in a particular geographic area via an embodiment of the present system, then a mobile application installed on the user's mobile device may be automatically activated to enable social media (or “check-in”) functionality. Additionally, marketing content created via aspects of the present system can be viewed through the user's social media system application on the mobile device.

Referring again to the system generally, in embodiments, the campaign manager 120 may allow companies 112 to purchase plug computers on their account. These companies may then load content, set content rotation and time parameters, and may view reports and activity on the client devices 108 associated with the performance of a campaign (i.e., marketing content). The campaign manager may also act as a driver for the client devices.

In an embodiment, the campaign manager 120 may include a role management module (not shown). The role management module may include multiple levels to control access of the marketing platform 100. The levels may include super administrator, a company administrator, a company user, and other similar rolls. In embodiments, the super administrator may be provided access to control creation, editing, and deletion of accounts of a company, users, billing details, campaigns, and content of the marketing platform. Further, the company administrator may be provided control at a company/account level. For example, the company administrator may create, edit and delete users, campaigns and content, and view reports. Further, the company user may be able to create and edit campaigns and content, and view reports. However, for example, the company user may not be able to delete historical records. Furthermore, a client user (e.g., a user of a client device 108, such as a merchant location employee at which a client device is located) may only be able to view campaign reports and may be prevented from editing the content.

In embodiments, the campaign manager 120 may include a company account module (not shown). The company account module may enable creation, deletion and editing of a company account. Further, the company account module may include information of a company. Fields of information may include company name, address, city, state, postal code, phone number, primary contact name, billing address, billing frequency, and billing type. In an embodiment, the billing frequency may be customized as per requirements such as monthly billing, quarterly billing, annual billing, and the like. Further, the billing type may include invoice, credit card, and the like. In an embodiment, each client device 108 may be assigned to specific company accounts via serial numbers or MAC addresses that may enable control of the accounts remotely.

FIG. 3 illustrates an exemplary interface screen 300 of an embodiment of the proximity marketing system 100. The interface screen 300 may be displayed, for example, to system users 112 accessing the system 100 to create and or manage their marketing campaigns and related content. Alternatively, the screen 300 may be displayed to system administrators to view various campaigns and user information associated with system users 112. The exemplary screen shown in FIG. 3 includes a header region 302 that directs the user to other interfaces that enables various functionalities, including adding a new company to the system (this would be for use by a system administrator), creating users (e.g., enabling individual user accounts within a corporate user account), adding new client devices (e.g., associating devices with physical merchant locations), creating clients, and creating marketing campaigns. Exemplary map region 304 illustrates a map with icons 306 indicating the physical locations of active client devices 108. As will be understood and appreciated, map region 304 is shown for illustrative purposes only, and may include various levels of detail and specificity in terms of the size of the area shown, and other details.

In exemplary screen 300, underneath map region 304 is campaign region 308, which lists the active campaigns of the given user 112. Next to campaign region 308 is online device region 310, which describes the active client devices 108 currently deployed for the user 112. The exemplary interface screen 300 also includes other conventional regions, such as menu region 312 listing various functionalities of the present system 100, and other similar regions. As will be understood and appreciated, the interface screen 300 is provided for illustrative purposes only, and is not intended to limit the scope of the present disclosure in any way.

In embodiments of the present system, the interface screen 300 (and other similar screens) may be served via a dashboard module (not shown) within the central application server 102. The dashboard module may include a dashboard page (e.g., screen 300) that may be accessible to the users, once the users log into the campaign manager 120 of the marketing platform 100. The dashboard page may display an activity graph of the company 112. The activity graph may include information about various active projects of the company, daily activities, and the like. The dashboard module may allow the user to see past activities of the company such as for the last 30 days, last week, and the like. The user may choose a pie chart, a bar graph, and the like, which may show the past activities of the company. Further, the dashboard module may include a ‘my campaigns’ section (e.g., active campaigns region 308) that may display active campaign names hyperlinked for quick access. In an embodiment, the dashboard module may enable the user to see all client devices that may be online in a given area (e.g., online device region 310).

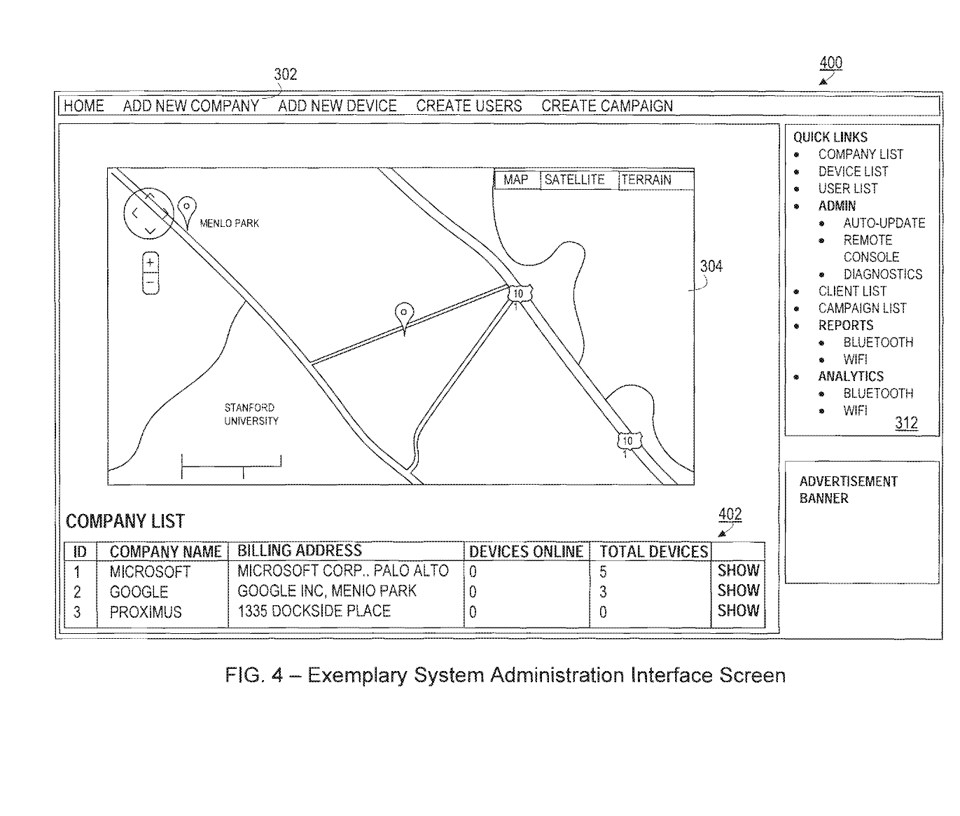

FIG. 4 illustrates an exemplary maintenance or administration screen 400 used by a system administrator of an embodiment of the present proximity marketing system 100. In one embodiment, the maintenance screen (or console) 400 may be accessed by a super administrator only. Further, the maintenance console may display all client devices 108 sold per user account. In an embodiment, the maintenance console may include a green indicator showing an online status and a red indicator showing an offline status (or other status indicator) of client devices 108 maintained by the system (e.g., see company region 402). The maintenance console may manage individual devices on any account. In an example, the maintenance console may be used to add, edit, and delete content, logs, and the like. In another example, the maintenance console may be used to troubleshoot devices on any account. In an embodiment, the maintenance console may be used to push new software/firmware to the individual plug computers.

Still referring to FIG. 4, in the embodiment shown, company region 402 lists exemplary users 112 associated with the present system 100. For each user, the name, billing address, total number of client devices, number of online devices, etc. are all displayed. In the exemplary screen 400, other regions, such as map region 304 showing active client devices 108, menu region 312, header region 302, and other similar regions are shown. For example, the map region 304 may be provided by a web mapping service application such as GOOGLE MAP™, and the like. Further, the map view may provide names of the companies who may have their client devices 108 placed in given locations. In addition, the menu region 312 may include quick links that the users 112 may access to get a list of campaigns, list of companies, list of devices, list of users, and the like.

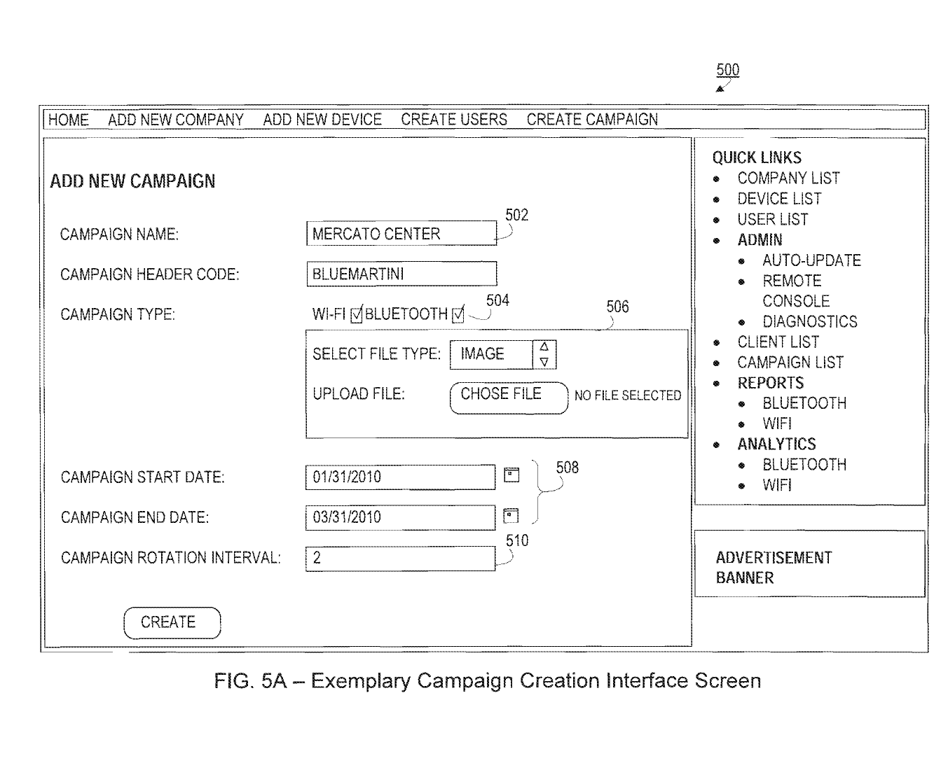

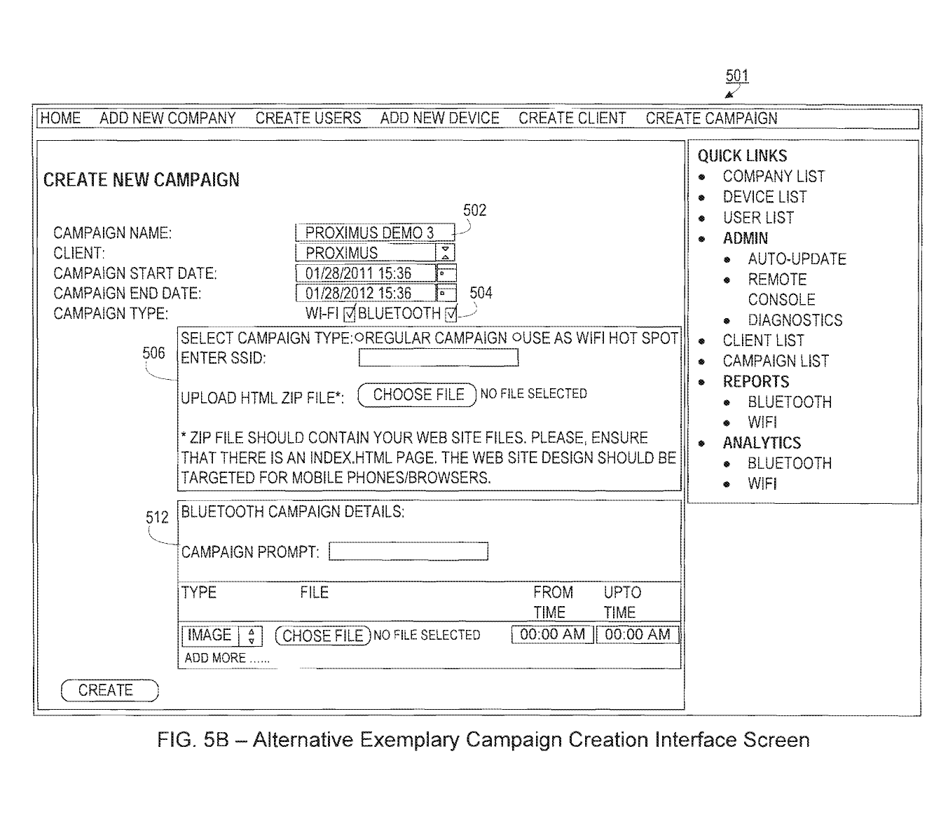

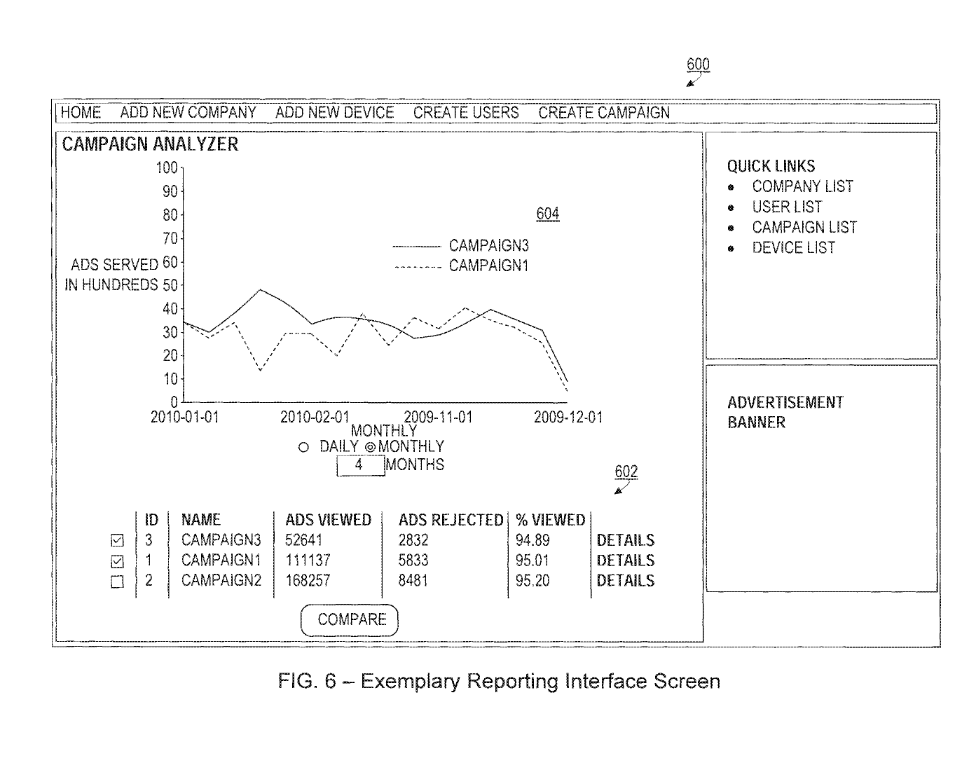

In embodiments of the present system 100, the campaign manager 120 may include functionality to enable system users 112 to create a new campaign for distribution via client devices 108. In one embodiment, the campaign manager includes a campaign module (now shown) that performs this functionality. In one embodiment, the campaign (which includes marketing content) may be a set of content and rules that may be pushed to end hardware devices 114, such as mobile phones, smartphones, PDAs, tablet computers, handheld devices, and the like. Further, the rules may include attachment of files for Bluetooth, and HyperText Markup Language (HTML) for WiFi. To create campaigns, the user 112 may be required to fill various fields such as a campaign name, campaign dates, etc. (described in greater detail herein in connection with FIGS. 5A and 5B). The campaign name may be provided by the user. Further, the user may create a 13-character name that may be used as a Prox SSID/Bluetooth header name. The 13 character name may be pushed to a client device 108.

FIG. 5A illustrates an exemplary campaign creation interface screen 500 that enables system users 112 to create and/or manage marketing campaigns within embodiments of the present proximity marketing system 100. In the embodiment shown, a user 112 may select a campaign name from a predefined list or may create a new name for a new campaign (see field 502). For example, the user may add a new campaign entitled “Mercato Center” to a list of current campaigns. Thereafter, the user may specify a type of the campaign (see field 504). For example, the user may select whether the campaign may be launched through either Bluetooth or WiFi, or both. As will be understood and appreciated, campaigns may be implemented using a variety of delivery mechanisms and communication protocols, including SMS and MMS messages, social media system postings (e.g., FACEBOOK™ or TWITTER™), email, and others, the those listed and described in connection with FIG. 5A are not intended to be limiting in any way. In an embodiment, the campaign parameters input via interface screen 500 may be sent to one or many client devices 108 for ultimate transmission to consumer mobile devices 114. The users may upload binary content, in the form of files, to the campaign (see field 506). The files may be a single file or multiple files. Further, the marketing content may be uploaded in files. The files may be single or multiple files. In addition, the user 112 may set a start date and end date for the campaign (see field 508). For example, the user may select Jan. 31, 2010 as the start date and Mar. 31, 2010 as the end date for the campaign.

In embodiments, if the campaign includes Wireless Application Protocol (WAP) content, the user may enter a Uniform Resource Locator (URL) to push the WAP content onto the mobile device 114. In embodiments, if the campaign includes WiFi content, pages created in content management system (CMS) may be utilized as marketing content within the campaign. In addition, the user 112 may set content rotation intervals and times (see field 510). The user may set a date and a time to send appropriate content file of the campaign.

Further, once received by the mobile device user 114, the client device 108 that is transmitting the given campaign may receive a single response from the mobile device, such as a YES or a NO, as opted by the user. For example, if a mobile phone user 114 rejects the content sent to the user, the client device 108 may not send that piece of content to that MAC address again. Specifically, in some embodiments, mobile devices 114 are identified as being in proximity to the client devices based on MAC addresses associated with the mobile devices. Once the mobile devices are identified, the given client device attempts to push campaign or marketing content to the mobile device. In some embodiments, the mobile device user has the option to accept such content, or reject it. Also, in some embodiments, the mobile device user may need to initially opt-in to receive such content from client devices 108. If the user “accepts” such content, then he or she will receive the pushed content on the mobile device 114. If the user “rejects” such content, then he or she will likely not receive further content (at least not from the specific client device 108 or system of client devices from which the content was originally transmitted). As will be understood and appreciated, mobile devices 114 may be identified in a variety of ways as will occur to one of ordinary skill in the art, and not merely via MAC addresses.

FIG. 5B illustrates an alternate embodiment of an exemplary campaign creation interface screen 501 that enables system users 112 to create and/or manage marketing campaigns within embodiments of the present proximity marketing system 100. As shown, many of the fields and regions are similar to those shown in FIG. 5A. However, screen 501 includes additional functionality to provide further insights, parameters, and criteria via details region 512. For example, if a user 112 selects delivery of the specific campaign via Bluetooth, then a Bluetooth campaign details region 512 may be displayed, which enables further configuration and criteria to be defined in connection with management and delivery of a campaign. Again, as will be understood and appreciated, various embodiments of interface screens and parameters associated with campaign creation are possible according aspects of the present system.

In embodiments, the campaign manager 120 of the marketing platform 100 may include a reporting module (not shown). The reporting module may facilitate generation of reports for users 112 or system administrators (see subsequent discussion herein in conjunction with FIG. 6). The reports may include a Bluetooth campaign summary report, a WiFi campaign summary report, a client device report, and the like. The Bluetooth campaign summary report may display an aggregated activity for a campaign. The campaign performance data that may be considered to prepare the Bluetooth campaign summary report (or virtually any report, for that matter) may include number of mobile devices detected 114 by one or more client devices 108, number of push attempts (i.e., number of times marketing content was pushed to mobile devices 114), number of successful downloads (i.e., number of times users of mobile devices received and downloaded the marketing content), number of rejections, response rate percentage, and the like. The response rate percentage may be calculated by dividing the number of successful downloads by the number of push attempts.

In an embodiment, the WiFi campaign summary report may include insights on website traffic and marketing effectiveness of a user's campaigns. The data that may be considered to prepare the WiFi campaign summary report may include the number of visitors (e.g., number of mobile devices 114 identified), unique visitors, a mobile device type, a browser type, and the like. In embodiments, the summary reports such as Bluetooth campaign summary report, WiFi campaign summary report, and the like may be filtered based on date ranges, campaigns, and the like. For example, the user 112 may filter the summary reports by time of a day, week, month, three months, six months, and the like. Further, the user may review real-time Bluetooth and WiFi campaign summary reports for the current campaigns.

In embodiments, the unit report may include data on a specific client device. The data may correspond to Bluetooth as well as WiFi campaigns. For example, the data may include information about the number of visitors to that client device, number of Bluetooth campaigns, number of WiFi campaigns, and the like.

Referring to FIG. 6, an exemplary reporting screen 600 is shown according to reports generated via an embodiment of the present system 100. In one embodiment, the reports maintained in the system 100 and shown via screen 600 are generated via the reporting module. The comparative report may provide details about various campaigns such as number of advertisements (e.g., marketing content, including webpages, discount offers, etc.) that may be viewed by the mobile device users, number of advertisements that may be rejected by the users, percentage of viewed advertisements, and the like (see region 602). Further, the comparative report may be generated over a month, three months, six months, and the like. The user may select any number of campaigns and compare the activities of the campaigns over a specific period of time. In addition, the comparative report may include activity graphs of data on multiple client devices 108 (see region 604). For example, the users may view comparative reports for Bluetooth and WiFi campaigns over a period of time.

In embodiments, the reports and analytics may include an aggregated report that may provide data about all activities of all online client devices 108. In some embodiments, the aggregated report may be accessed only by the super administrator. In other embodiments, various different users will be able to access certain reports. In an embodiment, the reporting module may generate a financial report of the super administrator. The financial report may display number of units purchased, monthly software billings, and the like. As described herein, the financial report may also be filtered by day, week, month, and year. In an embodiment, the reporting module may generate a financial summary report that may include data about the total number of client devices purchased and the total number of subscribers per user 112.

As described previously, in various embodiments, the content management system (CMS) may provide mobile website content to the users of mobile phones, PDAs, or other devices 114. The marketing platform 100 may include customizable user preferences that may allow a bespoke fit to any device 114. Further, the CMS may allow disabling of images by the users to reduce bandwidth/traffic. The CMS may be integrated with other content management systems such as JOOMLA!™, offered by Open Source Matters, Inc., SALESFORCE™, offered by Salesforce.com, Inc. of San Francisco, Calif., and the like. In embodiments, users may create Wireless Markup Language (WML), Extensible Hypertext Markup Language (xHTML), and HTML mini websites to be loaded on the client devices 108 for distribution to consumers via their mobile devices 114.

As described herein, the campaign manager 120 may be used to create/delete/edit accounts, campaigns, and the like. In embodiments, the campaign manager may include an admin/support module (not shown). The admin/support module may manage account billings and may be integrated with the CRM. In addition, the admin/support module may be the console to manage the client devices 108. The client devices may be interchanged by a unique serial number or MAC address associated with accounts. Further, the client devices may receive firmware updates, and may be reset, tested, and the like from an admin/support module in the central application server 102.

In embodiments, the marketing system 100 may support enhanced reporting, and offline loading and downloading of campaign content and logs. Further, the marketing platform 100 may support MySQL on a client device for data collection via HTML forms. In an embodiment, the marketing platform may also add video campaign functionality in the campaign manager to support certain client devices 108, such as a GuruPlug Display server from GlobalScale Technologies, Inc., for digital signage applications. In other embodiments, the campaign manager 120 may push campaign content and messages to various social networking websites such as FACEBOOK™, TWITTER™, and the like (see previous discussion in connection with FIG. 2). For example, if the campaign manager uploads a new campaign and content to one or more social networking websites, the users of such websites may be made aware of the new campaign and can view the content.

In an embodiment, the client devices 108 may utilize open source software that may implement JAVA Servlet and JavaServer Pages technologies, such as Tomcat6, for the WiFi content and to report clickthroughs. A configuration setting may be created in the campaign manager 120 that may configure the open source software implementing the JAVA Servlet and JavaServer Pages technologies on the client devices 108 to allow for a true “hot spot” (wireless) connection. In this process, mobile device users may register their mobile devices 114 with an embodiment of the present system 100, subsequently view campaign content, and then may be able to use the provided network connection to browse any Internet site.

In embodiments, and as described previously, the proximity marketing system 100 may enable transmission of SMS and MMS messages to mobile devices 114 of users. For example, companies 112 may create SMS and MMS campaigns that may include subscription alerts, transaction alerts, binary content (ringtones, etc.), contests, surveys/polls, and the like. Additionally, embodiments of the present system may allow for rich reporting and analytics, and enable building of profiles for opted-in subscribers.

Further, as described previously, the marketing platform 100 may be associated with one or more client devices 108 that may offer rules-based location messaging. Therefore, when a consumer who may have previously opted-in to the system passes near a client device, the user may receive a text message with a pre-defined offer (or other marketing content). This may be accomplished through integration with a location-based service (LBS) aggregator such as the Universal Location Service provided by Location Labs, or LOC-AID™, of San Francisco, Calif. The LBS aggregator may allow the marketing system 100 to pull location data from a mobile phone number and then prompt the system to generate the text message. The client device 108 may be located at any retail store, coffee shop, resort, casino, or virtually any other facility as will occur to one of ordinary skill in the art. When a consumer may come in proximity to a store or other location, the user may receive text messages related to discounts offered, new campaigns, and the like, on their mobile device 114.

In one embodiment, to enable rules-based location messaging (in the form of “geo-fencing”), a user 112 of the system 100 defines a virtual area or region that corresponds to an actual or physical area. For example, a user may interact with a map interface provided by the present system to define a specific “virtual” area that corresponds to a messaging “fence.” This virtual area could relate to, for example, a university campus, or a shopping mall, or a specific radius around a central point, or a city block, or a specific section of a building, etc. Once the virtual area has been defined, the location data and coordinates are sent to an LBS or to the mobile device carrier. Subsequently, when the LBS or carrier identifies that a mobile device user has entered the virtual region, the LBS or carrier sends a transmission to the present system indicating the same, and the mobile device user then receives a predetermined message relating to that virtual area (such as a marketing message created by the user 112 that defined the area). In one embodiment, mobile device users must have opted-in to receive messages from an embodiment of the present system prior to receiving such notifications.

In an example, assume that a virtual “geo-fence” has been defined for a food court in a shopping mall. As consumers walk into the food court, they may receive special offers, discount coupons, and the like on their mobile devices, upon turning on wireless technologies of their mobile devices (there may be a sign in the food court indicating the consumers should turn on the wireless communications functionalities of their mobile devices). For example, the coupon may offer a free drink along with a pizza slice at an Italian restaurant. The coupon may include a code such as AB1234 and may also include a time limit for the validation of the coupon. The users may show their mobile devices with the coupon displayed on the mobile devices to a cashier at the Italian restaurant to receive the offer or discount on the purchase. In this circumstance, the client device(s) 108 may be operated by the shopping mall, or the food court, or even the individual Italian restaurant.

In another example, a consumer may arrive at a hotel and casino in Las Vegas and may receive a text message from the hotel indicating the consumer's suite number. The text message may further include directions for the consumer to receive the room key. In an embodiment, as the consumer passes near the casino, the consumer may receive a text message that may offer a voucher for the consumer at any table in the casino. The text message may also include a code and expiration date of the voucher.

In embodiments, the marketing system 100 may utilize messaging, Bluetooth, and WiFi components (and other components) to enable location-based tracking of consumers. The benefit of tracking may be more analytical for foot traffic patterns and repeat customers. This tracking and measurement may also include matching MAC addresses for Bluetooth and WiFi to mobile number opt-ins and phone types. As a given user 112 may gather data by storing the Bluetooth and WiFi MAC addresses, the user may then begin to create and manage consumer profiles based on behavioral patterns in a given venue or retail establishment. With SMS and WiFi, the user may store mobile numbers and collected names and email addresses, and match that to the MAC addresses. This data may then become extremely valuable to the users (e.g., retailers and businesses) as they may begin to personalize offerings through SMS and Bluetooth.

In embodiments, the marketing platform 100 may gather additional data about consumers including mobile numbers, names, email addresses, device profiles, usage patterns, traffic patterns, dwell times (e.g., time in a given facility), and the like.

In embodiments, a website of the marketing system 100 may integrate into a CRM program for lead management and processing. E-commerce orders may create accounts in the CRM system and may generate the appropriate sales tracking reports. The campaign management login that may be provided at the website may link from the home page. Further, the credit card billing captured in the website may tie into the account settings in the campaign manager. Thus, when a given user 112 stops paying or a contract expires, the ability of the user to utilize the proximity marketing system 100 may end.

In embodiments, the CMS that may be used by the proximity marketing system may include Joomla, Drupal, or any other open CMS. Joomla may be written in JAVA and may store data in MySQL. Joomla may publish content on the Internet as well as a web application framework. Further, Joomla may include features such as page caching, RSS feeds, printable versions of pages, news flashes, blogs, polls, search functionality, and support for language internationalization. In an embodiment, Drupal may be another CMS that may be used by the present system. Drupal may also be written in JAVA, or other similar language.

In embodiments, the CRM system utilized may comprise SugarCRM, or other similar systems. SugarCRM is an open-source CRM that may be built on an open Source LAMPS platform such as MySQL, JAVA, Linux, and the like. Further, SugarCRM may be integrated with CMS such as Joomla, Drupal, and the like.

As mentioned previously, in various embodiments, the marketing system 100 may be used to establish marketing campaigns. The marketing system may be designed for two-way SMS interaction, Bluetooth broadcast, WiFi, email, and other similar communication protocols, Further, the marketing system may be managed entirely through a web-based system. In an embodiment, the marketing system may allow building and launching of SMS messaging, WAP Push, Bluetooth Push, and WiFi Web con tent creation to bring a rich dynamic experience to a mobile phone 114,

In embodiments, additional features of the marketing system 100 may include carrier interconnectivity through an SMS/MMS aggregator. The marketing system may provide short code or tong code connectivity. Further, the marketing system may facilitate use of a shared short code and may provide support for customer owned short codes. Moreover, the marketing system may be an intuitive and simple to use web-based application interface. In an embodiment, the marketing system may allow generation of customizable and sortable reports based on individual or aggregate campaigns. Furthermore, a secure administration website may allow media agencies to view reports, The marketing system may include an application programming interface (API) for custom campaign creation. In an embodiment, the marketing system may provide the ability to run simultaneous mobile campaigns for multiple users 112 and/or client devices 108. In embodiments, the marketing system may also provide the ability to run multiple mobile campaigns for each user 112 and/or client device 108.

Further, the marketing system 100 may assign multiple users 112 and/or client devices 108 to a short code or long code using unique keywords. In an embodiment, the marketing system may assign multiple keywords to each campaign. The marketing system may provide configuration for Mobile Originated (MO)/Mobile Terminated (MT) workflow. Iii embodiments, the marketing system may enable text voting, polling, reply menu selections, alerts, and drawings. Further, the marketing system may enable support capability for international messaging and long codes. In an embodiment, the marketing system facilitate phone device 114 detection recognition and content delivery. Furthermore, the marketing system may track campaign response and reporting. In an embodiment, administrative rights be provided to third parties for a limited read only access of the content of the marketing system. The marketing system may also enable message tracking and billing.

Described in greater detail below are one embodiment of the interaction between the application server 102, the control server 106, and the client devices 108. As mentioned herein, the application server may host an HTTP client that may be used to send control messages/parameters to the control server. Further, content may be loaded/updated/added to the database 110 using information that may be made available through the parameters. In an embodiment, a custom binary protocol may be used to communicate between the client device and the control server. In an example, the protocol format may include a common header. Such a header may be common for all messages and may include a length that may be represented by a 4 byte indicator. The 4 byte indicator may represent the entire message length. In an embodiment, once a value of a part of the length may be read, the entire message may be constructed by collating values of all parts. Further, the common header may include a Msg Id that may indicate a type of protocol message. Examples of protocol messages may include, but are not limited to, FILE_TRANSFER_CAMPAIGN, FILE_TRANSFER_LOGS, and STATUS_ALIVE. In an embodiment, the protocol format may include message-specific data (referred as “message data”). The message data may include data that is specific to the protocol message.

The following is an exemplary table illustrating various types of request messages that may be sent to the client devices 108 and the response received from the client devices in accordance with an embodiment of the present disclosure. It will be understood and appreciated that the following table is provided merely for illustrative purposes only, and embodiments of the present system 100 will utilize a variety of types of messages and responses as will occur to one of ordinary skill in the art.

| | REQUEST | RESPONSE |
|---|---|---|
| 1 | Length ==> 4 bytes [Total msg length] | Length ==> 4 bytes [Total msg |
| | Msg_Id ==> 4 bytes, Value = | length] |
| | FILE_TRANSFER_CAMPAIGN_INIT | Msg_Id ==> 4 bytes, Value = |
| | FileSize ==> 4 bytes Value = FileSize to | FILE_TRANSFER_CAMPAIGN_INIT_ACK |
| | be sent | |
| | ChunkSize ==> 4 bytes, Value = Block | |
| | Size = 8 k(Configurable) | |
| 2 | Length ==> 4 bytes | Length ==> 4 bytes |
| Loop | Msg_Id ==> 4 bytes, Value = | Msg_Id ==> 4 bytes, Value = |
| | FILE_TRANSFER_CHUNK | FILE_TRANSFER_CHUNK_ACK_OK |
| | ChunkOffset ==> 4 bytes, Value of the | [indicates chunk was received |
| | current chunk, is updated when an ack is | properly] OR |
| | received from the client and the file | FILE_TRANSFER_CHUNK_ACK_FAIL |
| | pointer incremented to read the next | [indicates failure in reading |
| | chunk | the chunk and the server will |
| | ChunkData ==> [ChunkSize] bytes, | retransmit current chunk] |
| | contains the file buffer | |
| 3 | Length ==> 4 bytes | Length ==> 4 bytes |
| | Msg_Id ==> 4 bytes, Value = | Msg_Id ==> 4 bytes, Value = |
| | FILE_TRANSFER_OVER [indicates that | FILE_TRANSFER_OVER_ACK |
| | the file transfer operation was complete] | [indicates that the client has got the |
| | | file and that it has reset its state] |
| 4 | Length ==> 4 bytes | |
| | Msg_Id = 4 bytes, Value = | |
| | FILE_TRANSFER_ABORT | |
| | This message is sent when the file transfer | |
| | is aborted from the server side. Can | |
| | happen because of an exception on the | |
| | server. | |

In embodiments, a user 112 may trigger the dispatch of a campaign through a user interface (UI) (see, e.g., screens 500 and 501), once the user creates a campaign. The dispatched campaign may include parameters that may be passed to the control server 106 via HTTP. In an example, the parameters may include a Campaign_id, a Company_id, and the like. Further, the control server may fetch the campaign data from the database 110. The campaign data may include media files, XML configuration to display information, XML configuration for the ad-serving policy, and the like. The campaign data may be packaged in a compressed zip bundle and the protocol interaction may be limited to transfer of file buffers. In an example, a first message that may be sent from the server 106 to the client device 108 may include ‘FILE_TRANSFER_CAMPAIGN_INIT’. The protocol message in this case may include length of 4 bytes, a Msg_Id containing 4 bytes length, and a value ‘FILE_TRANSFER_CAMPAIGN_INIT’. Further, the file size may be 4 bytes and may include a value ‘FileSize to be sent’. Furthermore, the chunk size may be 4 bytes and may have a value equivalent to a block size, i.e., 8 k (configurable).

In embodiments, the client device 108 may respond to the first message. The response may include a length of 4 bytes and a Msg_Id of 4 bytes having a value ‘FILE_TRANSFER_CAMPAIGN_INIT ACK’. Again referring to the above table, it may include similar request and response cases as explained here. Further, the client device 108 may uncompress the files and place them in a JAVA content-server directory, once the zipped file is downloaded. The uncompressed files placed at the JAVA content-server directory may be ready to be used.

In embodiments, log files may be dispatched through a protocol interaction that may be identical to the above described interaction. The client device 108 may act as a file server and may transmit the files to the control server 106. The control server may push the files to the database 110.

In embodiments, “keep alive” messages may be used to convey the status of a client device 108. The client device may send this message to the server 106 periodically, which is configurable. If the server 106 is not be able to receive this message, the server may update the device status in the database and may mark it as disconnected. Further, the protocol message format may be illustrated in the table below.

| | Request | Response |
|---|---|---|
| 1 | Length ==> 4 bytes msg | Length ==> 4 bytes |
| | [Total msg length] | [Total msg length] |
| | Msg_Id ==> 4 bytes, Value = | Msg_Id ==> 4 bytes, Value = |
| | STATUS_ALIVE | STATUS_ALIVE_ACK |

Aspects of the present disclosure generally relate to systems and methods for delivering proximity-based marketing content to mobile devices. According to one embodiment, companies or marketers generate content (e.g., advertising content, promotional offers, discounts, interactive promotional content, etc.) to be distributed to mobile devices (e.g., cellular telephones, smartphones, etc.) of consumers as those consumers become geographically proximate to physical locations associated with the companies or marketers. According to one embodiment, a central application server is used for purposes of generating and managing marketing content, and that content is transmitted to various client devices, routers, and/or servers (e.g., “plug” computers) for further distribution to mobile devices within a proximate range of the client devices. In one aspect, the client devices identify consumer mobile devices within a predetermined geographic area that is proximate to the client devices (e.g., based on a media access control (MAC) address associated with the mobile device), and push marketing content to those mobile devices for display to the consumers. In various embodiments, the consumers can then view marketing content, or “redeem” offers contained within the marketing content, for example, by showing the offer displayed on the consumer's mobile device to a representative at the physical company or marketer location, or by engaging in some other redemption mechanism (described in greater detail above).

Additionally, in one embodiment, aspects of the present system may track consumer interaction with marketing content over time to provide helpful analytics and insight into consumer purchasing behavior, the success of different types of marketing content, the success of different types of delivery mechanisms (e.g., Bluetooth v. WiFi), the physical movement patterns of consumers (e.g., through a shopping mall, casino, sports stadium, etc.), and other related marketing performance information. In other embodiments, this marketing performance information may be used to build consumer profiles for individual consumers such that subsequent marketing content may be specifically targeted or tailored to that user's preferences. For example, if it is determined over time that a given consumer only engages with certain types of content delivered via aspects of the present system, then those types of content can be highlighted and specifically sent to that consumer in the future, regardless of whether the consumer is proximate to a physical company or marketer location or not. In this example, if it becomes apparent that a given consumer will often respond to discount offers in connection with men's clothing, then certain men's clothing marketers may begin to send such discount content to the consumer's mobile device (based on pre-stored contact information) on a periodic basis, regardless of the consumer's physical location.

According to yet a further embodiment, aspects of the present system include operative connections to social media systems, such as FACEBOOK™, TWITTER™, FOURSQUARE™, and the like. In such embodiments, aspects of the present system may offer marketing content to consumers in connection with “check-in” features (or other location-based aspects) of these social media systems. For example, if a given mobile device user “checks in” at a merchant location via a social media system, then that mobile device user may automatically receive a marketing offer associated with that merchant location. Alternatively, if a user's mobile device is identified by a client device (e.g., “plug” computer) associated with an aspect of the present system, then that mobile device may be sent not only marketing content associated with a given marketer or company, but also may be automatically “checked in” via the mobile device user's social media accounts. Those of ordinary skill in the art will understand and appreciate that other social media tie-ins are contemplated by aspects of the present system, and are not limited to those specifically described herein.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, LTE, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. In a proximity marketing computer system, a method for managing the delivery of marketing content to mobile devices of consumers, wherein the marketing content is created by one or more users of the proximity marketing computer system, and wherein the proximity marketing computer system comprises one or more client devices physically located at one or more facilities, comprising the steps of:
receiving a request at the proximity marketing computer system for transmission of marketing content to the one or more client devices for subsequent delivery to mobile devices;
retrieving the marketing content from a database associated with the proximity marketing computer system;
transmitting the retrieved marketing content to the one or more client devices that are physically located at the one or more facilities;
identifying a mobile device within a predetermined physical proximity of a particular client device at a facility; and
transmitting the retrieved marketing content to the identified mobile device for display to a mobile device user.

2. The method of claim 1, wherein the one or more client devices comprise one or more of: plug computers, servers, wireless routers, wireless access points.

3. The method of claim 1, wherein the one or more facilities comprise one or more of: retail locations, resorts, casinos, merchant locations, shopping malls, hospitals, airports, universities, office buildings, restaurants.

4. The method of claim 1, wherein the marketing content is associated with a particular system user.

5. The method of claim 1, wherein the marketing content is pre-created by a system user.

6. The method of claim 1, further comprising the step of receiving authorization information from the identified mobile device to enable distribution of marketing content to the mobile device.

7. The method of claim 1, wherein the step of transmitting the retrieved marketing content to the one or more client devices further comprises:
initiating a file download session between a central server within the proximity marketing computer system and the particular client device, wherein the file includes the marketing content;
extracting the downloaded file to a predefined directory accessible to a content serving module within the particular client device; and
loading the downloaded file and adding the downloaded file to a current content list capable of distribution to mobile devices.

8. The method of claim 1, wherein transmission of the retrieved marketing content to the identified mobile device is accomplished via a wireless communication protocol.

9. The method of claim 1, wherein the predetermined physical proximity is defined by a system user.

10. The method of claim 1, wherein the predetermined physical proximity is determined based on communications capabilities of the particular client device.

11. The method of claim 1, wherein the mobile device is identified via its media access control (MAC) address.

12. The method of claim 1, wherein the mobile device user can redeem the displayed marketing content at the facility associated with the particular client device.

13. The method of claim 1, further comprising the steps of:
receiving marketing performance data from mobile devices indicating mobile device user interaction with marketing content; and
generating consumer profiles based on the received marketing performance data, wherein the consumer profiles are indicative of mobile device user behaviors.

14. The method of claim 13, wherein the mobile device user behaviors comprise one or more of: physical movement of mobile device users through a facility, relative success of marketing content, buying patterns of mobile device users, buying preferences of mobile device users.

15. A computer program product comprising a computer readable medium having a computer executable program code embodied therein, said computer executable program code adapted to be executed on one or more computer devices to perform the steps of:
detecting a mobile device using a client device, wherein the mobile device is operating a wireless communication protocol;
accessing an advertising campaign database that is associated with the client device in order to select advertising content, wherein the advertising content relates to a commercial entity to which the client device and mobile device are proximate;
receiving the advertising content at the client device; and
distributing the advertising content to the mobile device.

16. The computer program product of claim 15, wherein the client device is selected from the group comprising: a plug computer, a server, a wireless router, a wireless access point.

17. The computer program product of claim 15, wherein the distribution of the advertising content is made using one or more of: SMS, MMS, a cellular phone call, an electronic transmission.

18. The computer program product of claim 15, wherein the selection of the advertising content is based at least in part on information that is associated with the mobile device.

19. The computer program product of claim 15, wherein the wireless communication protocol is Bluetooth.

20. The computer program product of claim 15, wherein the wireless communication protocol is a WiFi network.
